(19) United States
(12) Patent Application Publication
(10) Pub. No.: US 2005/0061639 A1
(43) Pub. Date: Mar. 24, 2005

(54) Switch stabilizer

(76) Inventor: Roderick W. Stringwell, Keokuk, IA (US)

Correspondence Address: BLANK ROME LLP, 600 NEW HAMPSHIRE AVENUE, N.W., WASHINGTON, DC, 20037, US

(21) Appl. No.: 10/665,013

(22) Filed: Sep. 22, 2003

(51) Int. Cl. H01H 9/26

(52) U.S. Cl. 200/5 R

(57) ABSTRACT

A multi-directional switch for use in actuating a motor, such as a motor associated with a power mirror on a motor vehicle. The switch includes an assembly of components, one of which is a stabilizer that contacts and aligns the assembly of components when a force is applied to a button on the switch. By aligning and supporting the components, the stabilizer allows the components to can displace in approximately a straight and true line regardless of the angle of the force applied to the button, thereby providing proper switch operating characteristics, improving reliability, minimizing inadvertent short circuits and reducing replacement costs.

### BACKGROUND OF THE INVENTION

1. Field of Invention

The present invention relates generally to electronic controls, and more particularly, to a multi-directional switch made from an assembly of components, one of which is a stabilizer for improved switch performance and reliability.

2. Description of the Prior Art

Multi-directional electronic control switches are ubiquitous in the automotive industry, especially in modem motor vehicles. They can be used by a vehicle operator to control various automotive electronic systems such as power windows, mirrors, seats, foot pedals, steering wheels, and audio-visual devices. For example, bi-directional switches are often included in motor vehicles for use in controlling power window lifts and the position of the corresponding window glass. Bi-directional switches have also been installed for use in controlling the position of power seats relative to the interior of the vehicle. Bi-directional switches have also been installed for use in controlling the telescoping movement of steering wheels and the position of acceleration/braking pedals. Multi-directional switches are frequently installed on in-dash radios, navigation systems and video systems to facilitate their use by the motor vehicle occupants.

U.S. Pat. No. 6,344,619 discloses a typical multi-dimensional switch adaptable for use in motor vehicles. As shown in FIGS. 13 and 14 of that patent, the switch has a box-like case or housing 1 containing several electrical contacts 15, 16; a dome-like circular contact 8; a movable contact 9; a rod-like manipulating shaft 23, and a manipulation knob 24 located at the end of the shaft. As described in the patent, the switch facilitates movement of a device, such as an outside mirror of a motor vehicle, when an operator presses or pushes the knob 24 causing the force applied to the knob to be transmitted through the shaft 23 to the dome-like contact 8. The contact 8 is then displaced by the shaft and engages a portion of the movable contact 9, which in turn contacts one or more of the electrical contacts 15, 16 to complete an electronic circuit. Once the circuit is energized, it actuates a motor that drives the mirror to a desired position.

The benefits of multi-directional switches are obvious. For example, without a multi-directional switch, a motor vehicle operator would have to locate and manipulate as many as four separate devices to position a mirror or seat. For safety reasons, having one switch capable of performing different functions increases the efficiency at which a task can be accomplished and allows the vehicle operator to focus on driving instead of the mirror switches.

Multi-dimensional switches are not limited to the automotive industry, however, nor are they unique to industrial uses. They are also found on consumer goods such as mobile phones, pagers, home audio-visual equipment, remote controllers, gaming machines, kitchen equipment, cameras, watches and many other products.

U.S. Pat. No. 5,378,862, for example, discloses a multi-directional “pivot” switch for use on a wristwatch. The switch, as shown in FIGS. 1 and 2, has an operating button 5 connected to a shaft 14 at its center and supported on its bottom face by the top end of four shafts 15 that are disposed essentially at four opposite sides and near the edges of the button. The four edges of the button correspond to the functions marked as “up,” “down,” “rev” (reverse) and “fwd” (forward) on the button as shown in FIG. 4. As described in the patent, the switch facilitates access to and manipulation of information stored in the watch electronics when an operator presses the top of the bottom. A switching lever 19 in the form of a leaf spring comprises four movable contacts 19a that are maintained in contact with the bottoms of the four shafts 15. When the button is pressed, the shafts displace the movable contacts 19a toward fixed contacts on a circuit board 23 to complete an electronic circuit. Once the circuit is energized, the circuit can perform its intended function.

The ever-increasing utility of multi-dimensional switches and their relatively compact size and low cost has bred a myriad of improvements on the basic multi-dimensional switch design over the years. Nevertheless, there have been, and continue to be, problems with multi-dimensional switches that limit their utility and acceptance for certain applications. For example, because multi-dimensional switches are assembled from many smaller parts in a stacked arrangement, and because tolerances for those components may not be too tight, off-axis and angled forces applied to the actuator button can cause bending and torsional forces to act on the stacked components. Ideally, the forces should act parallel and coincidentally to the longitudinal axis of the shafts so that the components operate in a straight and true line through the contacts to provide optimal switch operating characteristics and performance.

The problem can be addressed, to some degree, by separating the manipulation button into two or four smaller buttons arranged in close proximity to each other, and providing each individual manipulation button with its own manipulating shaft that is connected to a movable contact. In this configuration, the forces applied at an angle on one of the manipulation buttons relative to the longitudinal axis of the shaft, which creates transverse forces relative to the longitudinal axis of the shaft, can be controlled. U.S. Pat. No. 5,111,011 illustrates this approach. In that patent, the multi-directional mirror switch has four push buttons 116 arranged in a square pattern on the face of a casing 112 as shown in FIG. 1. The buttons can be pressed individually or two at a time (i.e., the “left” and “down” buttons can be pressed simultaneously to cause the mirror to move at an angle left and down). As shown in FIG. 9, each manipulation button is connected to a shaft 138 that slidably moves in an opening lined with a contact. A coil spring 160 returns the shaft and manipulation button to its original position after the force applied to the button is removed. Obviously, while this approach at separating the multi-directional switch into separate buttons may increase reliability over some single-button devices, it adds to the manufacturing costs and complexity of the device. Thus, a single manipulation button is preferred in some applications.

Another problem in prior art multi-directional switches, as described in the above listed patents, is that they lack adequate and consistent tactile response or “feel.” For example, for safety reasons, a motor vehicle operator needs to receive perceptible feedback that a mirror is actually moving in response to a switch button being depressed so the operator does not have to actually observe the mirror moving. Absent an audible response, the button needs to provide that perceptible feedback through touch. One problem associated with stacked components that have inherent wobble due to off-axis or angled forces acting one them is that the tactile response may be different each time depending on how the button is pressed by an operator.

The lack of adequate tactile response or “feel” in multi-directional switches has been addressed in various ways. Typically, a resiliently deformable member, such as a rubber or synthetic rubber diaphragm or cone assembly is disposed between the manipulation button and the electrical contact. When the button is pushed down, the deformable member provides some resistance to the motion of the shaft attached to the button until the force applied to the button exceeds the inherent bending stiffness of the deformable member and causes it to displace. The sudden displacement of the deformable member provides a tactile sensation. When the force applied to the button is removed, the resilient nature of the deformable member returns the button to its original position. U.S. Pat. No. 4,992,631 discloses the use of cone-shaped deformable members 43 that are used for that tactile response or “feel” aspect of the switch. U.S. Pat. No. 5,111,011 discloses the use of a coil spring 160, but a spring does not provide the same sudden displacement feel caused when the bending stiffness of the deformable member is overcome by the force applied to the button.

Typically, a force applied off-axis relative to the deformable member may need to be greater than a force acting normal to the axis of the deformable member to effect the same response and overcome the inherent bending resistance of the member. In the case of a force applied to the periphery of a manipulation button of a multi-directional switch, the off-axis force may not provide the same tactile response that a force applied normal and closer to the center of the button does. Thus, the user of the device may not receive a uniform tactile response or feedback from the switch, depending on the position and angle of the force applied to the manipulation button. This is illustrated in FIGS. 12 and 13 of U.S. Pat. No. 4,975,547. In that patent, the problem is partially addressed by use of an angled projection 56 that partially compensates for the angled force applied to the deformable member so that when the projection engages the top of the member at the point of maximum force, it is parallel to the top of the member. As a result, the force being applied by the projection to the top of the member will be generally uniformly distributed. Unfortunately, as shown in FIG. 13, the projection will not always be parallel to the top surface of the deformable member.

In FIG. 3 of U.S. Pat. No. 4,896,003, the lack of tactile feedback is addressed in another manner. As shown in the figure, a resilient disk-shaped support member 30 is positioned over individual contacts 41. The force applied to one edge of the actuator button 23 is transferred to the flange 26 which contacts the support member 30 at a raised portion 34 on the member. That force is then transferred through the raised portion 34 of the support member 30 and moves the contact 41 to the conductive metal strip 16 to complete the electrical circuit. Obviously, the flange 26 moves in a path corresponding to the dimension of the ball bearing 50. Thus, the normal component of the forces applied to the contact 41 will change as the flange moves in its radius of curvature. The support member 30 has web portions 32, 35 that extend away from raised portion 34 to partially compensate for that problem. Those portions tend to help straighten out the raised portion 34, laterally, as the flange rotates. However, the support member 30 will never be parallel to the conductive metal strip 16 so only one edge of the contact 41 will engage the metal strip 16 until a sufficient force is applied to the actuator button 23 to push the contact 41 fully against the metal strip 16.

Finally, consumers have demanded products that are smaller and of lighter weight. Making components smaller is not feasible in all cases, so eliminating unnecessary components, or combining the function of two components into a single component, is one way to reduce weight, and also reduces manufacturing costs.

### SUMMARY AND OBJECTS OF THE INVENTION

In view of the foregoing, it should be apparent that there exists a need for a multi-directional switch that adequately compensates for the various angled forces applied to the internal components of the switch to increase its reliability and enhancing tactile response.

Accordingly, it is a principal object of the present invention to provide a single button, multi-directional switch with a stabilizer component that directs forces in a prescribed direction to provide more uniform and efficient engagement of the electrical contacts.

It is another object of the present invention to provide stabilizer components that enhance the tactile response of the button and thereby provide a uniform expected perceptible feedback for the user.

It is still another object of the present invention to provide a multi-directional switch having a stabilizer component and that is adaptable for use in a motor vehicle for remotely controlling the position of various mechanical systems.

It is another object of the present invention to provide a stabilizing component that can universally adapt to existing multi-directional switches without the need to significantly redesign the existing switch.

It is still another object of the present invention to provide a stabilizer component that allows for a greater gap between movable contacts and conducting strips when the contacts are at rest to eliminate potential, inadvertent short circuits during operation.

Briefly described, these and other objects and features of the present invention are accomplished, as embodied and fully described herein, by a multi-component switch having a housing; a button; a retainer; four drivers; a stabilizer; a tactile interface with a series of cone-shaped, resilient, deformable members; a contact card; a circuit board; a terminal header; and a connector shroud. The stabilizer provides balance to the drivers and allows the stack up of components to operate in a straight and true line parallel to the longitudinal axis of the switch, which reduces improper displacement of the deformable members. As a result, the stabilizer provides improved proper switch operating characteristics and a more uniform tactile feedback. With the addition of a stabilizer, a larger gap is possible between the bottom of the drivers and the top of the deformable members, which greatly reduces or eliminates potential inadvertent short circuits during switch operations. Thus, while the addition of a stabilizer to the switch adds cost to the device, the savings are gained by extending the reliability and useful life of the switch.

With these and other objects, advantages and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a drawing of a perspective view of a multi-directional switch in an assembled configuration according one embodiment of the present invention;

FIG. 2 is a drawing of a perspective, exploded view of the multi-directional switch in FIG. 1 showing the components of the switch, including a stabilizer;

FIG. 3 is a partial top plan view of the multi-directional switch in FIG. 2 shown partially assembled;

FIG. 4 is a top plan view of the stabilizer in FIG. 2;

FIG. 5 is a top plan view of another stabilizer according to the present invention;

FIG. 6 is a top plan view of still another stabilizer according to the present invention;

FIG. 7 is a top plan view of yet another stabilizer according to the present invention;

FIG. 8 is a drawing of a partial cross-sectional view of the assembled multi-directional switch in FIG. 1;

FIG. 9 is a perspective cross-sectional view of the tactile interface component of the multi-directional switch in FIG. 2; and

FIG. 10 is a drawing of the partial cross-sectional view of the assembled multi-directional switch in FIG. 8 depicting a simulation of the actuator button being depressed on one edge by application of a force.

### DETAILED DESCRIPTION OF THE PREFERRED EMBODIMENT

Several preferred embodiments of the invention are described for illustrative purposes, it being understood that the invention may be embodied in other forms not specifically shown in the drawings.

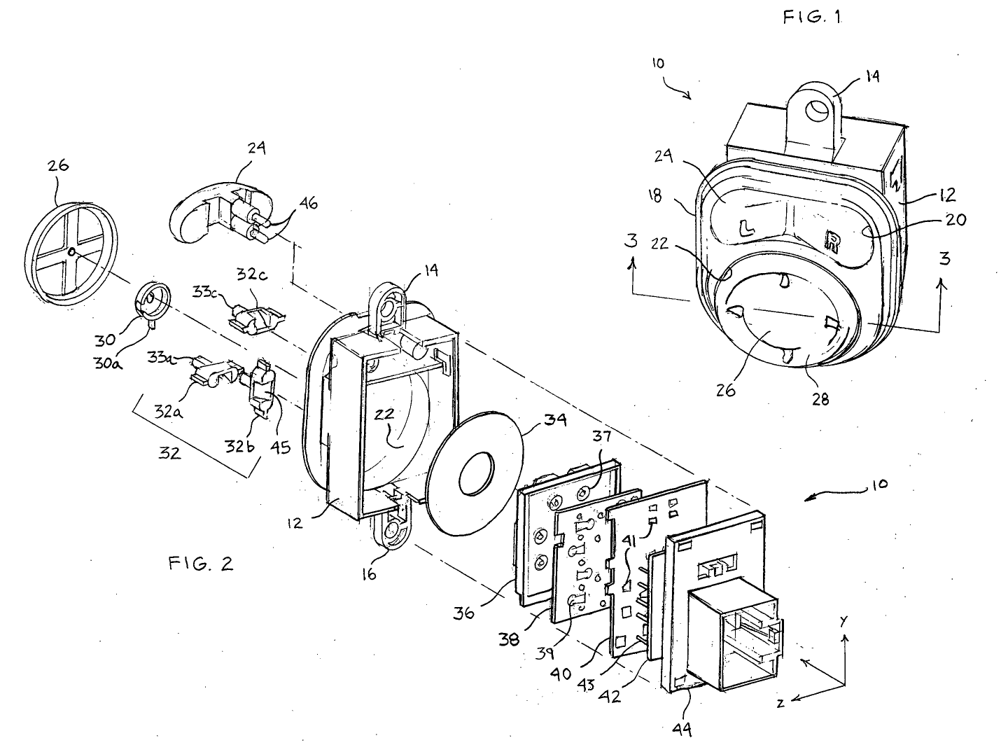

Turning first to FIG. 1, a perspective view of a multi-directional switch 10 according to one embodiment of the present invention is shown. Switch 10 includes a housing 12 that includes two oppositely extending flanges 14, 16 (only one of which is shown). The flanges 14, 16 are used to connect the switch 10 to a substrate surface (i.e., an automobile door assembly) using fastening devices. The housing 12 is made out from an inexpensive, thermal-moldable polymeric material, but any suitable material may also be used by itself or in combination with other materials (e.g., metal).

The top of the housing 12 forms a decorative front fascia 18, which, in the embodiment shown, has a rounded appearance (although any shape is within the scope of the invention). Typically, the switch 10 is mounted in such a way that only the fascia 18 is visible to an operator. The fascia 18 is made from the same material as the rest of the housing 12, but it could also be made out of a different material (e.g., brushed aluminum, burled walnut, carbon fiber, etc.).

The fascia 18 has openings 20, 22. Within the opening 20 is a bi-directional toggle 24 that extends above the fascia 18. Within the opening 22 is a multi-directional actuator button 26 that also extends above the fascia 18. Both the toggle 24 and button 26 have indicia thereon which may or may not be back-illuminated. The toggle 24 has two circuit-engaging positions: left and right. A neutral position is also provided. The button 26 is movable to any circuit-engaging position from the neutral center position by applying a force to the surface of the button near the peripheral edge 28 of the button 26. The toggle 24 and the button 26 are made out of the same polymeric material as the housing 12, but may be made out of a different material to match the fascia 18.

FIG. 2 is a perspective exploded view of the multi-directional switch 10 in FIG. 1. As shown in FIG. 2, the components of the switch 10 include the following: the toggle 24; the button 26; a retainer 30; a driver 32 (including separate drivers 32a, 32b, 32c and 32d (not shown)); the housing 12; a stabilizer 34; a tactile interface 36; a contact card 38; a circuit board 40; a terminal header 42; and a connector shroud 44.

The toggle 24 includes two spring loaded contact pins 46 that, when the switch 10 is assembled, engage an electrical conductive plate located on the circuit board 40.

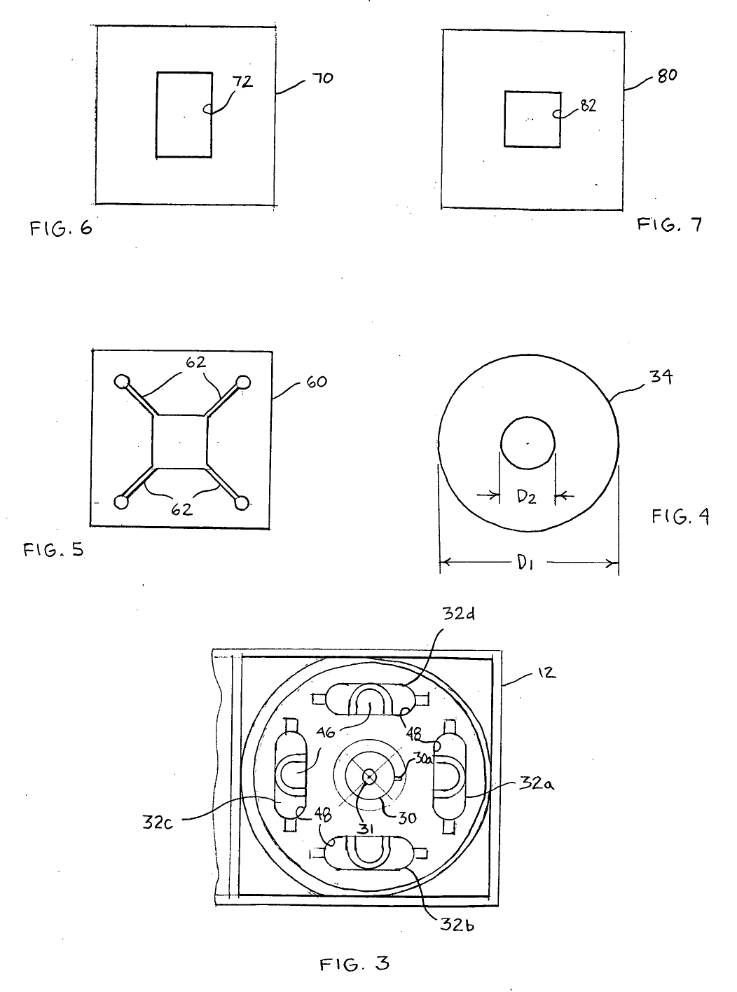

The retainer 30 has tab 30a that engages the back side of the facia and is used to connect the button 26 to the fascia 18 using a fastener 31. This is best seen in FIG. 3, which shows a partial plan view of the interior of the housing 12 according to the present invention.

The four drivers 32a, 32b, 32c and 32d, which are used to transfer a force acting on the button 26 to the movable contacts on the contact card 38 (discussed later), are positioned at ninety-degree angles under the button 26. Each of the drivers 32a, 32b, 32c and 32d includes a longitudinally extending pin 33 that inserts into a corresponding opening (not shown) on the back of the button 26. A slot 45 on the drivers 32 provides for illumination of the indicia on the face of the button 26 by means of a light pipe (not shown) inserted into the slot 45 or by another illumination device. The drivers 32a, 32b, 32c and 32d are positioned in openings 48 in the fascia 18. The openings 48 restrict the displacement of the driver 32 to a direction that is approximately parallel to the longitudinal direction of the switch 10. In this manner, even if a force that is applied to the top surface of the button 26 is not directly over the top of one of the longitudinally extending pins 33 on the drivers 32, the drivers 32 will displace primarily in a direction that is approximately parallel to the longitudinal direction of the switch 10. However, to facilitate proper operation of the switch 10, the tolerance between the drivers 32 and the openings 48 may not be too small. Thus, the drivers 32, to some degree, are allowed to move transversely relative to the longitudinal direction of the switch 10.

The bottom (back sides) of the drivers 32 are supported by, and directly contact, the stabilizer 34, which is shown as a washer-like flat disk. The stabilizer 34 is preferably made of Teflon®, Surlyn® or Polypro®, which are materials ideally suitable for satisfying the purposes of the stabilizer 34 and capable of tolerating the environment in which the stabilizer 34 is exposed. The stabilizer 34 is preferably made using a die cut machine, but other methods are also suitable.

FIG. 4 is a top plan view of the stabilizer 34 in FIG. 2. The annulus dimensions of the disk are defined by D1 and D2. Preferably, D1 is 10 millimeters and D2 is 32 or 33 millimeters. Those dimensions will obviously be modified depending on the size of the housing 12 and the location of the drivers 32 relative to the button 26. The thickness of the stabilizer 34 is preferably 0.2 millimeters, ±0.08 millimeters, but depends on the material used. Any structurally reasonable thickness is allowed so long as the stabilizer 34 satisfies the purpose of its intended use (as described previously). In some cases, a gap between the bottom of the drivers 32 and the top of the tactile interface 36 may be larger than the thickness of the stabilizer 34. Thus, there will be a small gap remaining between the bottom of the drivers 32 and the top of the tactile interface 36 even with the stabilizer 34 positioned between those two components.

FIGS. 5-7 show various other possible, but not exclusive, shapes for the stabilizer 34. In FIG. 5, the square-shaped stabilizer 60 has an opening 62 formed by a cut-out portion in the center of the stabilizer 60. In FIG. 6, the square-shaped stabilizer 70 has a rectangular opening 72 formed by a cut-out in the center of the stabilizer 70. Similarly, in FIG. 7, the square-shaped stabilizer 80 has a square opening 82 formed by a cut-out in the center of the stabilizer 80.

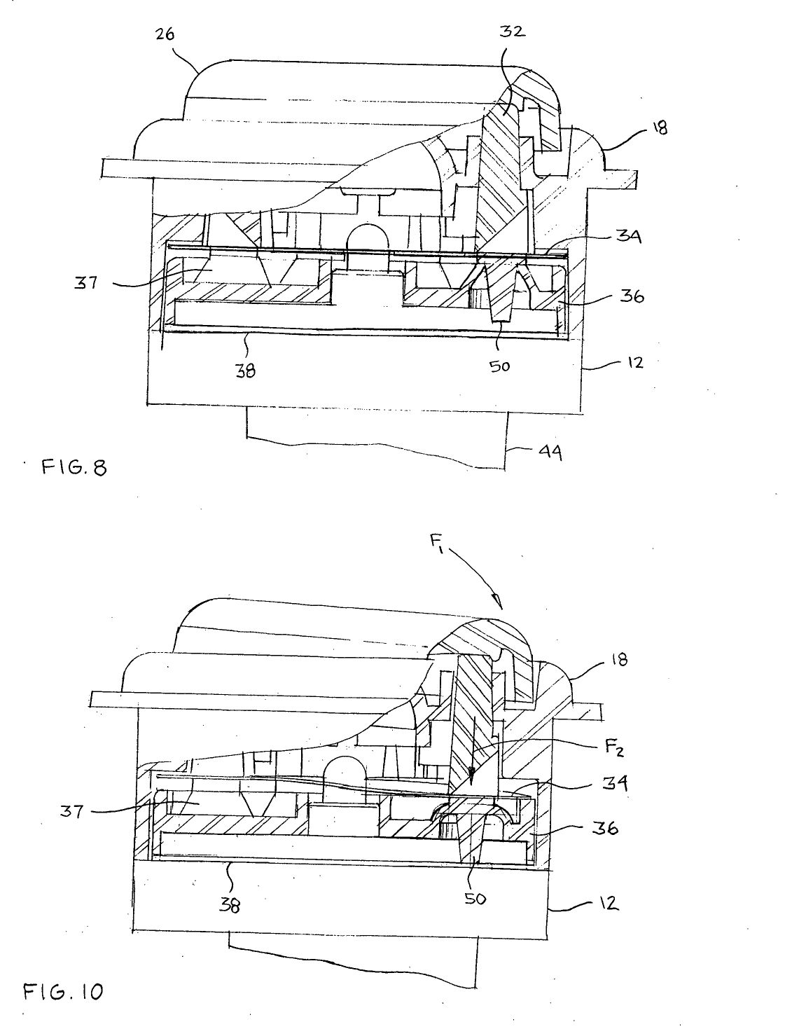

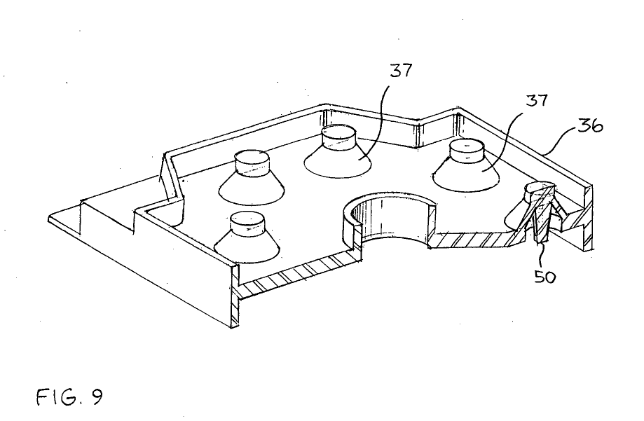

Returning to FIG. 2, the tactile interface 36 is positioned behind the stabilizer 34. The tactile interface 36 includes a series of resilient, deformable, cone-shaped members 37 positioned to be in-line with the drivers 32. The top of the cone-shaped members projects forward from the main portion of the tactile interface 36 and contacts the back side of the stabilizer 34 (as best seen in FIG. 8). The bottom, or pointed end 50 (FIG. 9) of the cone-shaped members 37, is directed toward the rear of the switch 10 and the contact card 38. The tactile interface 36 is preferably made of silicon or some other suitable resilient material.

Positioned behind the tactile interface 36 is a contact card 38 containing a series of metallic contacts 39 (FIG. 2) positioned behind the pointed ends of the cone-shaped members 37 on the tactile interface 36. The metallic contacts 39 are attached to the contact card 38 in a cantilevered manner that allows the metallic contacts 39 to displace in a resilient manner when engaged by the pointed ends 50 of the cone-shaped members 37.

Proceeding the contact card 38 is a circuit board 40 partially encased in plastic. The circuit board 40 includes a series of metallic, electrical conducting strips 41 positioned behind the metallic contacts 39 on the contact card 38.

Proceeding the circuit board 40 is a terminal header 42. The terminal header 42 contains a series of longitudinally extending conductor pins 43 that are electrically connected to the circuit board 40. The other end of the conductor pins 43 is engaged to an electrical connector (not shown) that is inserted into and removably coupled to the connector shroud 44. The conductors that extend from the electrical connector are attached to a logic circuit associated with and controlling a remote mechanical device (not shown). That remote device could be, for example, a motor for moving a window, mirror, seat, foot pedal, or steering wheel in a motor vehicle.

FIG. 8 is a drawing of a partial cross-sectional view of the assembled multi-directional switch 10 in FIG. 1, shown in its neutral position, i.e., without any forces acting on the actuator button 26. Without any forces acting on the button 26, the cone-shaped members 37 engage the bottom of the stabilizer 34 and displace it to a neutral position due to the resilient nature of the cone-shaped members 37. Those cone-shaped members 37, in turn, engage the bottom of the drivers 32. The drivers 32 are in contact with and support the button 26 and maintain it in the shown horizontal or neutral position.

FIG. 10 is a drawing of the partial cross-sectional view of the assembled multi-directional switch 10 in FIG. 8 depicting a simulation of the actuator button depressed on one edge by application of a force F1. The normal or longitudinal component of that force, F2, is transmitted through the following stacked components: the drivers 32, the stabilizer 34, the cone-shaped members 37, the pointed ends 50, and the metallic contacts 39. As shown in FIG. 10, the stabilizer 34 partially flexes or bends in response to the transfer of force F2 through the stacked components to line up perpendicular to the force F2 (i.e., transverse to the longitudinal direction of the switch 10). By flexing that way, the drivers 32 are prevented from wobbling transversely and are axially aligned with the cone-shaped members 37 (see also FIG. 9). Thus, the stacked components operate in a straight and true line through to the metallic contacts 39.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. A multi-directional switch comprising:
a button;
a first driver positioned behind the button;
a stabilizer positioned behind the first driver; and
a first deformable projection positioned behind the first driver,
wherein when a force is applied to the button the stabilizer engages the first driver and the first deformable projection thereby displacing the first driver and the first deformable projection in substantially a linear direction.

2. The multi-directional switch of claim 1, further comprising:
a second driver positioned behind the button and adjacent the first driver; and
a second deformable projection positioned behind the second driver and adjacent the first deformable projection,
wherein when a force is applied to the button the stabilizer engages the first and second drivers and the first and second deformable projections thereby displacing the first and second drivers and the first and second deformable projections in substantially a linear direction.

3. The multi-directional switch of claim 2, further comprising:
a first contact positioned behind the first deformable projection; and
a first conductive plate positioned behind the first contact.

4. The multi-directional switch of claim 3, further comprising an electrical terminal header positioned behind the first conductive plate, the terminal header comprising:
a first plurality of spaced apart and extending conductor pins at least some of which are contacting the first conductor plate; and
a second plurality of spaced apart and extending conductor pins that are electrically connected to the first plurality of conductor pins for coupling with an electrical connector.

5. The multi-directional switch of claim 1, further comprising
a housing, comprising:
a fascia;
a shell attached to the fascia;
a back plate attached to the shell; and
a connector shroud attached to the back plate,
wherein the fascia includes an opening for receiving the buttons;
wherein the shell encloses the first driver, the stabilizer disk, and the first deformable projection; and
wherein the connector shroud is adaptable for receiving therein, and coupling to, a connector.

6. The multi-directional switch of claim 1, wherein the stabilizer is an annulus.

7. The multi-directional switch of claim 1, wherein the stabilizer is a square.

8. The multi-directional switch of claim 7, wherein the square stabilizer includes one of a square and rectangular opening cut out of the center of the square stabilizer.

9. The multi-directional switch of claim 7, wherein the square stabilizer includes a square opening cut out of the center of the square stabilizer and four cut-outs extending from the comers of the square opening.

10. The multi-directional switch of claim 1, wherein the switch is mounted in a motor vehicle for use in actuating a motor.

11. A multi-directional switch comprising:
a circular button;
four drivers positioned behind the circular button;
a stabilizer disk positioned behind the four drivers;
a deformable projection positioned behind each of the four drivers;
a contact positioned behind each of the deformable projections; and
a conductive plate positioned behind the contacts,
wherein when a force is applied to the button the stabilizer engages the drivers and the deformable projections displacing the drivers and the deformable projections in substantially a linear direction.

12. The multi-directional switch of claim 1 1, further comprising
a housing, comprising:
a fascia;
a shell attached to the fascia;
a back plate attached to the shell; and
a connector shroud attached to the back plate,
wherein the fascia includes an opening for receiving the circular buttons;
wherein the shell encloses the drivers, the stabilizer disk, the deformable projections, the contacts and the conductive plate, and
wherein the connector shroud is adaptable for receiving therein, and coupling to, a connector.

13. The multi-directional switch of claim 12, wherein the switch is mounted in a motor vehicle for use in actuating a motor.

14. A multi-directional switch comprising:
button means for receiving a force applied thereto;
driver means positioned behind the button means for transferring the force applied to the button means;
deformable projection means positioned behind the first driver means for transferring the force applied to the first driver means;
contact means positioned behind the first deformable projection means for transferring the force applied to the first deformable projection means;
conductive plate means positioned behind the first contact means for engaging the first contact means; and
stabilizer means positioned between the driver means and the deformable projection means for stabilizing the driver means and the contact means when the force is applied to the button means.

15. The multi-directional switch of claim 14, further comprising:
housing means for enclosing components;
fascia means attached to the housing means for covering a front of the switch;
shell means attached to the fascia means for enclosing the driver means, the stabilizer means, the deformable projection means, the contact means and the conductive plate means;
back plate means attached to the shell means for covering a rear of the switch; and
connector shroud means connected to the back plate means for receiving a connector,
wherein the fascia means includes an opening for receiving the button means.

16. The multi-directional switch of claim 15, wherein the switch is mounted in a motor vehicle for use in actuating a motor.
